(19) United States
(12) Patent Application Publication
(10) Pub. No.: US 2013/0051025 A1
(43) Pub. Date: Feb. 28, 2013

(54) TABLE LAMP HAVING A LAMP SHADE THAT CAN DISPLACE TRANSVERSALLY AND ROTATE BY 360 DEGREES

(71) Applicant: Vincent Lai, Gueishan Hsiang (TW)

(72) Inventor: Vincent Lai, Gueishan Hsiang (TW)

(21) Appl. No.: 13/217,248

(22) Filed: Aug. 25, 2011

(51) Int. Cl. F21V 21/14

(52) U.S. Cl. 362/269

(57) ABSTRACT

A table lamp having a lamp shade that can displace transversally and rotate by 360 degrees is assembled by a bottom seat, a slide base, a connecting rod, a rotation mechanism and a lamp shade. An interior of the slide base on the bottom seat is installed with a sliding mechanism, enabling the slide base to displace on the bottom seat. A top end of the connecting rod above the slide base is installed with the rotation mechanism and the lamp shade is installed at an upper end of the connecting rod. When the connecting rod tilts, the slide base shifts naturally on the bottom seat using a center of gravity, enabling the lamp shade to displace opposite to a direction at which the slide base shifts. The lamp shade displaces transversally on the connecting rod or rotates by 360 degrees on the connecting rod by the rotation mechanism, so as to change a location of the lamp shade.

### BACKGROUND OF THE INVENTION

a) Field of the Invention

The present invention relates to a table lamp having a lamp shade that can displace transversally and rotate by 360 degrees, and more particularly to a table lamp wherein a lower side of a connecting rod is provided with a slide base and when the slide base is sliding on a bottom seat, the connecting rod or the lamp shade will tilt due to a natural gravity. In addition, the lamp shade can displace transversally on the connecting rod or rotate by 360 degrees on the connecting rod by a rotation mechanism, thereby changing a location of the lamp shade.

b) Description of the Prior Art

A conventional table lamp is usually formed by a bottom seat, a connecting rod and a lamp shade. The connecting rod is connected on the bottom seat, the lamp shade is connected on the connecting rod and an interior of the lamp shade is provided with a light emitting element. As the connecting rod and the lamp shade of the table lamp are all fixed structure and cannot be adjusted, only a fixed light source can be provided without changing a location and a direction of the lamp shade.

### SUMMARY OF THE INVENTION

Accordingly, the primary object of the present invention is to provide a table lamp, wherein an upper side of a bottom seat is installed with a slide base which is connected with a connecting rod, a rotation mechanism is connected at a top end of the connecting rod and a lamp shade is installed at an upper end of the connecting rod. When the connecting rod tilts, the slide base will shift naturally on the bottom seat due to a center of gravity, enabling the lamp shade to displace toward a direction opposite to the direction at which the slide base shifts; whereas, the lamp shade can displace transversally on the connecting rod or rotate by 360 degrees on the connecting rod by the rotation mechanism, so that the location of the lamp shade can be changed.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a schematic view of the present invention.

FIG. 2 shows an exploded perspective view of the present invention.

FIG. 3 shows an exploded view of a lamp shade and a rotation mechanism of the present invention.

FIG. 4 shows a three-dimensional perspective view of the present invention.

FIG. 4-1 shows a local blow-up diagram of the part B in FIG. 4 of the present invention.

FIG. 4-2 shows a local blow-up diagram of the part A in FIG. 4 of the present invention.

FIG. 5 shows a schematic view of a connecting rod which is perpendicular with respect to a bottom seat of the present invention.

FIG. 6 shows a schematic view of the connecting rod which is inclined with respect to the bottom seat of the present invention.

FIG. 7 shows a schematic view of the connecting rod which is perpendicular with respect to the bottom seat and the lamp shade displaces transversally on the connecting rod of the present invention.

FIG. 8 shows a schematic view of the lamp shade which rotates by 360 degrees on the connecting rod of the present invention.

### DETAILED DESCRIPTION OF THE PREFERRED EMBODIMENTS

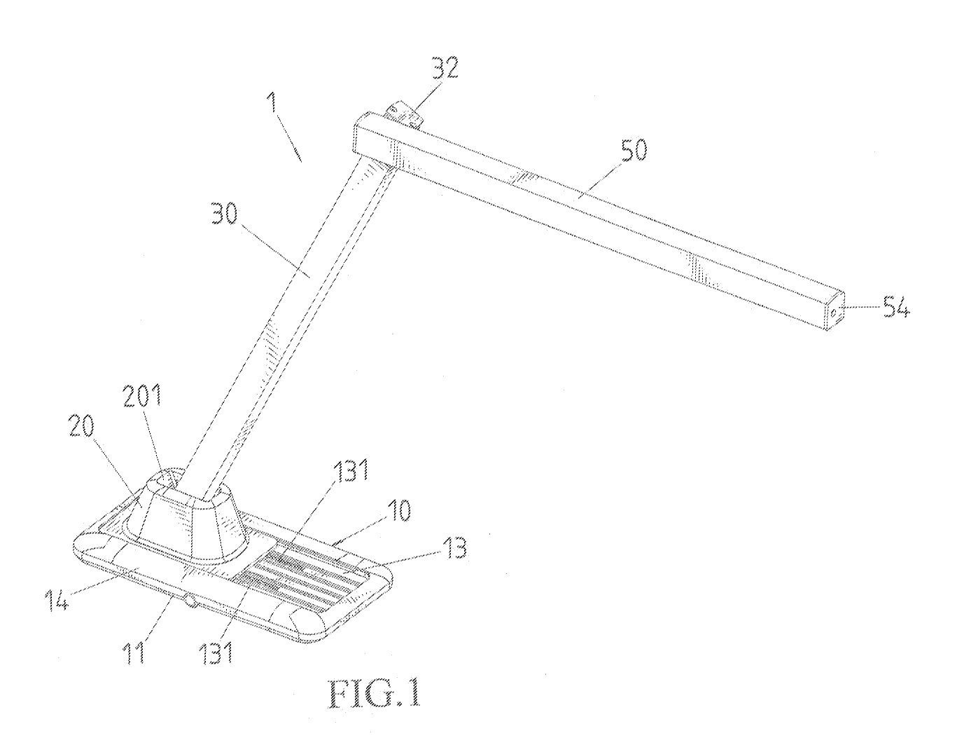

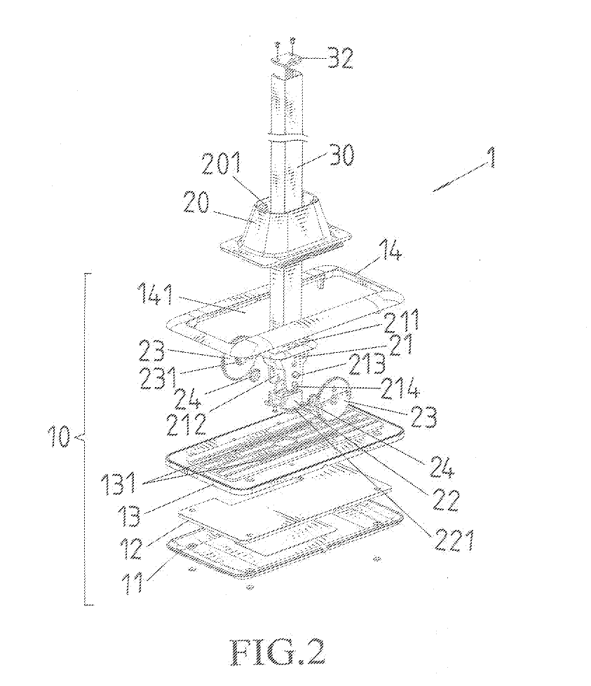

Referring to FIG. 1 and FIG. 2, an LED (Light Emitting Diode) table lamp 1 of the present invention comprises:

a bottom seat 10 which is constituted by a lower cover 11, a bottom plate 12, a top plate 13 and an upper cover 14, wherein the bottom plate 12 is put on the lower cover 11, the top plate 13 is put on the bottom plate 12, the upper cover 14 is put on the top plate 13 which is provided with two parallel toothed rails 131, and a center of the upper cover 14 is provided with an open slot 141;

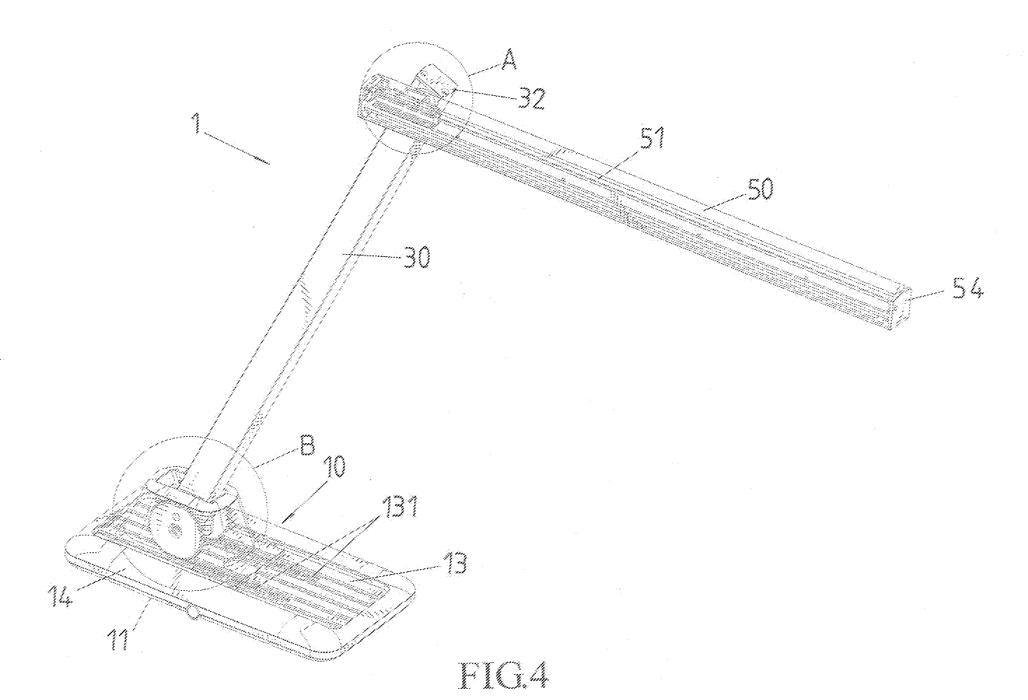

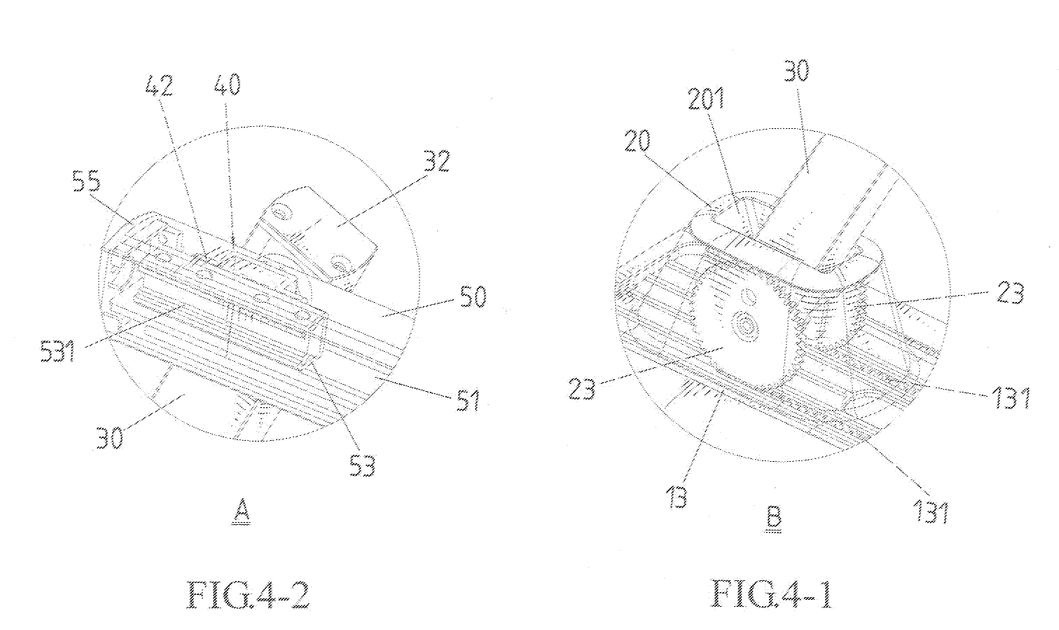

a slide base 20, an interior of which is installed with a sliding mechanism constituted by a connecting-rod seat 21, a gear seat 22, and two sets of large and small gears 23, 24, wherein an upper side of the connecting-rod seat 21 is provided with an opening 211, a lower side is provided with a U-shaped slot 212, and two sides are provided respectively with an upper and lower pivot 213, 214 which can be pivoted respectively with the large and small gear 23, 24, whereas a supplementary gear 231 at an interior side of the large gear 23 is gnawed with the small gear 24, bottoms at two sides of the U-shaped gear seat 22 are provided respectively with an arc-shaped tooth row 221, and when the U-shaped slot 212 of the connecting rod 21 is covered on the gear seat 22, the large gears 23 are gnawed with the toothed rails 131 of the top plate 13 (as shown in FIG. 4-1), and the small gears 24 are gnawed with the tooth rows 221 of the gear seat 22;

a longitudinal connecting rod 30, a bottom end of which penetrates a seat hole 201 of the slide base 20 and is latched in the opening 211 of the connecting-rod seat 21, with that an inner side at a side, which is in an open shape, of the connecting rod 30, is provided with a rabbet 31, a top end of which is locked with a cover 32;

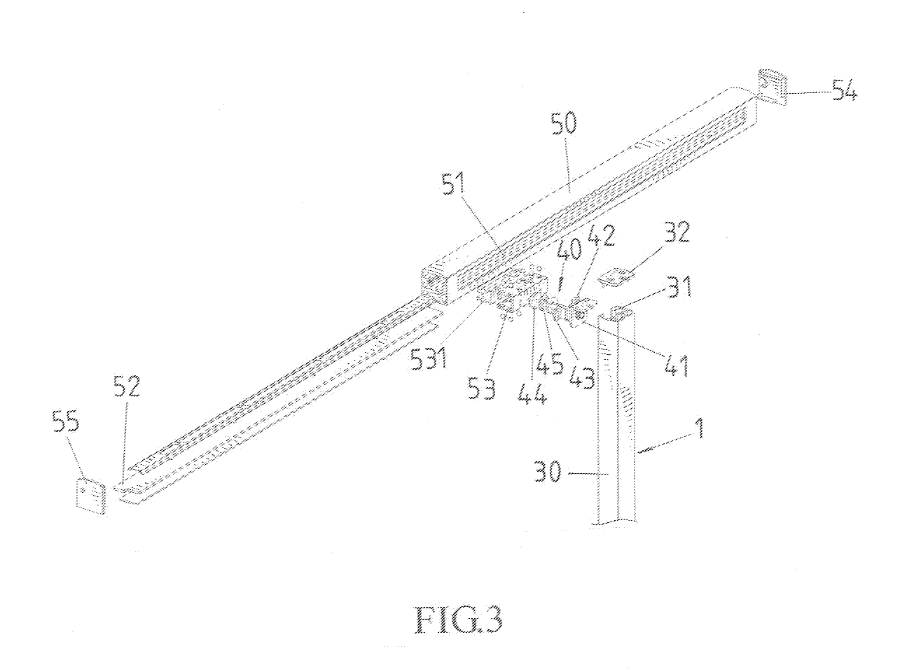

a rotation mechanism 40, referring to FIG. 3, which includes an L-shaped piece 41, a U-shaped piece 42, two fixing pieces 43, 44 and a rotation element 45, wherein the L-shaped piece 41 is latched in the rabbet 31 of the connecting rod 30, the two fixing pieces 43, 44 and the rotation element 45 are put in the U-shaped piece 42, the fixing piece 43 is connected with the U-shaped piece 42 and the U-shaped piece 42 is combined with the rotation element 45; and

a transversal lamp shade 50 which is installed at an upper end of the connecting rod 30 and an interior of which is provided with an opened slide rail 51, with that a bottom end of the slide rail 51 is installed with a light emitting element 52 such as an LED or a light tube, and referring to FIG. 4-2, the slide rail 51 enables the U-shaped slide base 53 to be put in, an interior of the slide base 53 is installed with an aluminum element 531 and a side of the slide base 53 is connected with another fixing piece 44 of the rotation mechanism 40; the lamp shade 50 being able to displace transversally on the slide rail 51 by the slide base 53 and even being able to rotate by 360 degrees on the connecting rod 30 by the rotation mechanism 40, whereas two ends of the slide rail 51 of the lamp shade 50 being locked respectively with a cover 54, 55.

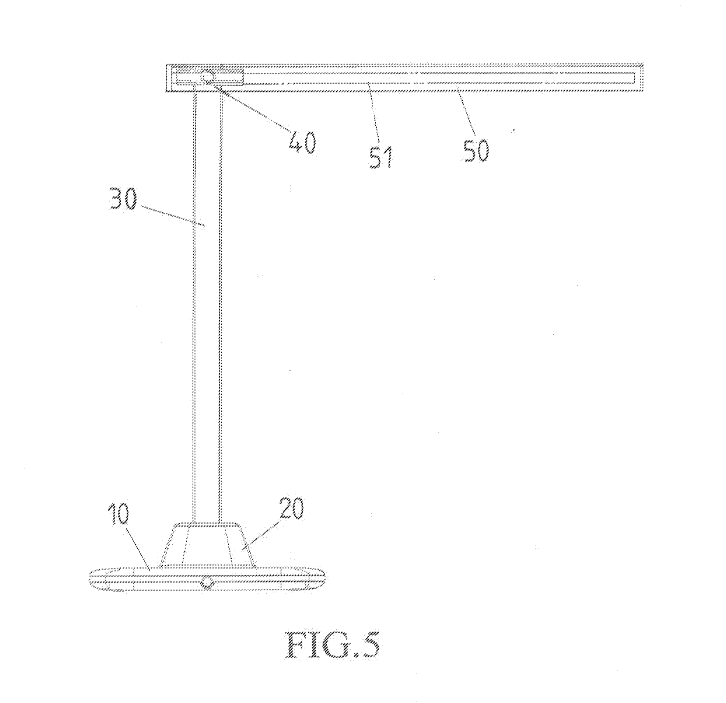

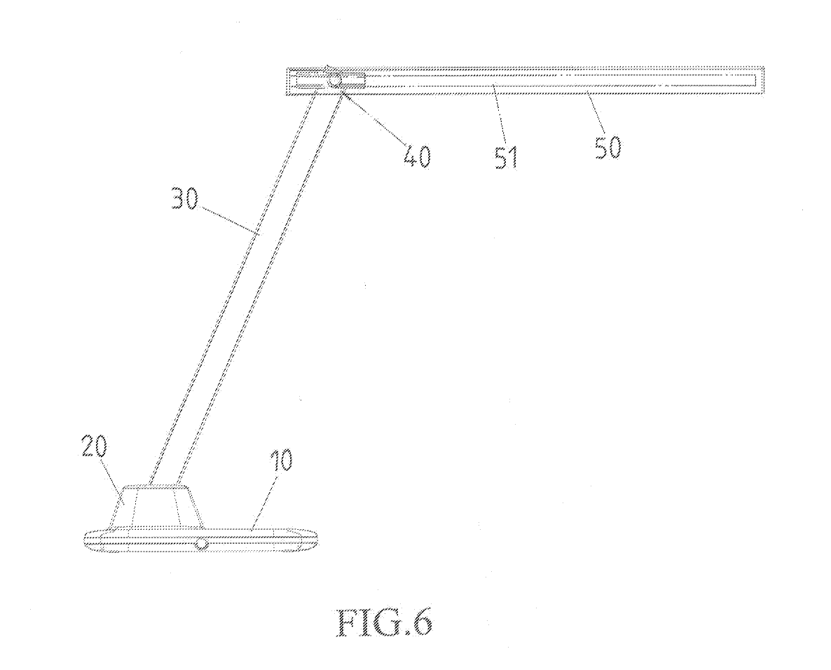

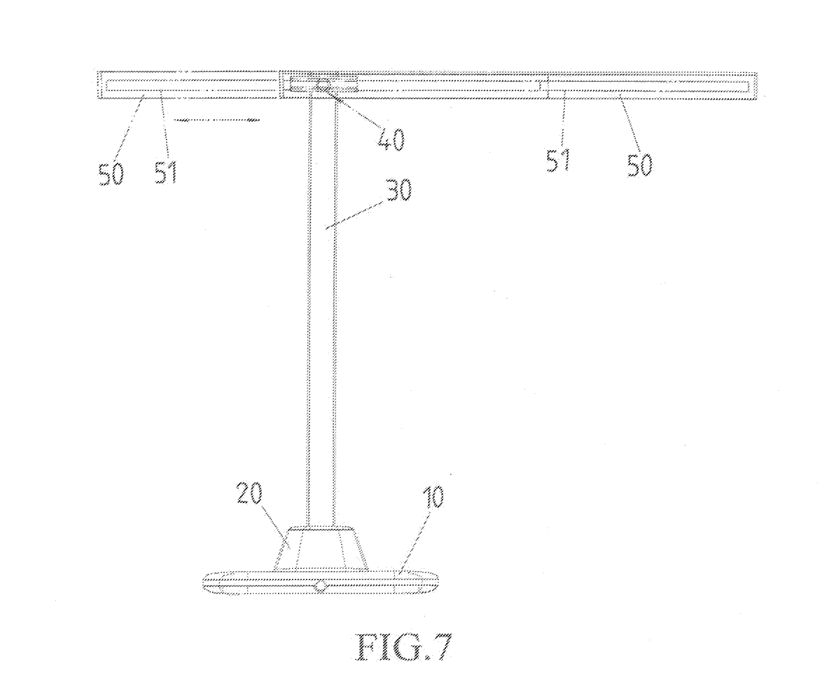

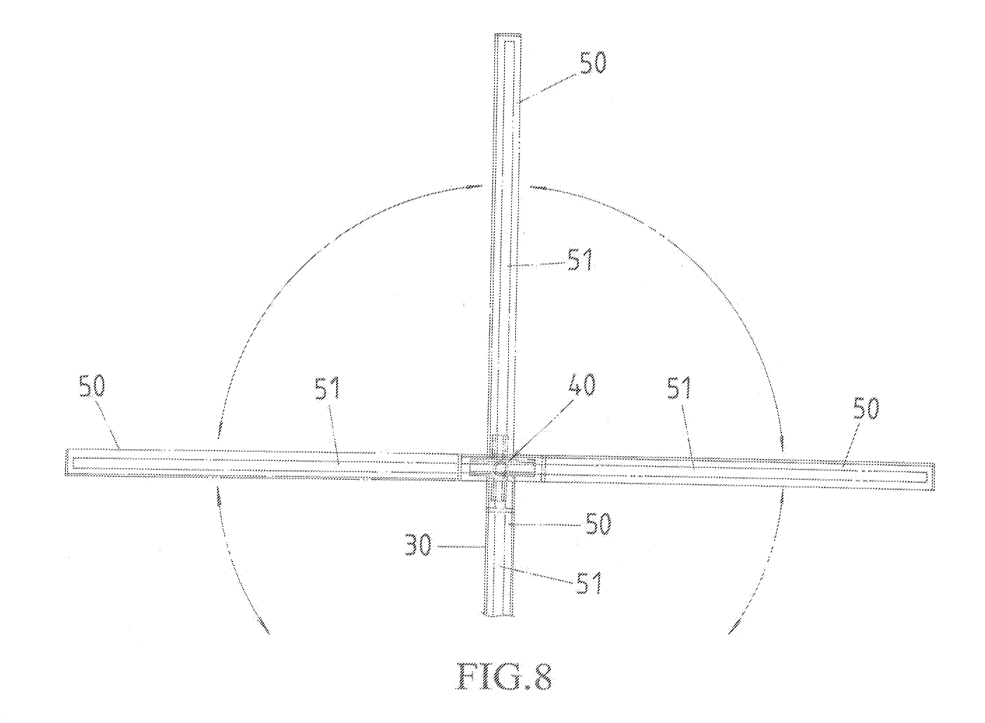

Referring to FIG. 5, it shows a schematic view of the connecting rod 30 which is perpendicular with respect to the bottom seat 10. Referring to FIG. 6, when the connecting rod 30 tilts toward right, which drives the lamp shade 50 to displace rightward, a center of gravity of the slide base 20 will naturally displace toward a left side of the bottom seat 10. Referring to FIG. 7, when the connecting rod 30 is perpendicular with respect to the lamp shade 50, the lamp shade 50 can display transversally on the connecting rod 30. Referring to FIG. 8, the lamp shade 50 can rotate by 360 degrees on the connecting rod 30 against the rotation mechanism 40.

In conclusion, the present invention is to provide a table lamp having a lamp shade that can displace transversally and rotate by 360 degrees, when the connecting rod of the table lamp tilts, the slide base will naturally shift on the bottom seat using the center of gravity. Therefore, the lamp shade can easily displace opposite to the direction at which the slide base shifts. In addition, the lamp shade can displace transversally on the connecting rod or rotate by 360 degrees on the connecting rod by the rotation mechanism, thereby changing the location.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A table lamp having a lamp shade that can displace transversally and rotate by 360 degrees, comprising:
a bottom seat;
a slide base, which is located on the bottom seat and an interior of which is installed with a sliding mechanism used to enable the slide base to displace on the bottom seat;
a connecting rod, which is fixedly provided on the slide base and an interior of which is provided with a rabbet;
a rotation mechanism which is connected at a top end of the connecting rod; and
a lamp shade which is installed at an upper end of the connecting rod; for the table lamp assembled by the abovementioned parts, when the connecting rod tilts, the slide base shifting naturally on the bottom seat using the center of gravity, allowing the lamp shade to displace toward a direction opposite to the direction at which the slide base shifts, with that the lamp shade displaces transversally on the connecting rod or rotates by 360 degrees on the connecting rod by the rotation mechanism, thereby changing the location.

2. The table lamp having a lamp shade that can displace transversally and rotate by 360 degrees, according to claim 1, wherein the bottom seat includes an upper cover, a lower cover, a top plate and a bottom plate, the bottom plate is put on the lower cover, the top plate is put on the bottom plate, the upper cover is put on the top plate, the top plate is provided with two parallel toothed rails and a center of the upper cover is provided with an open slot.

3. The table lamp having a lamp shade that can displace transversally and rotate by 360 degrees, according to claim 1, wherein the sliding mechanism of the slide base includes a connecting-rod seat, a gear seat, two large gears and two small gears, with that an upper side the connecting-rod seat is provided with an opening, a lower side is provided with a U-shaped slot, two sides are provided respectively with two pivots which are pivoted respectively with the large and small gears, a supplementary gear inside the large gear is gnawed with the small gear, an arc-shaped tooth row at a bottom of each of two sides of the gear seat is gnawed with the small gear and the large gear is gnawed with the toothed rail of the top plate.

4. The table lamp having a lamp shade that can displace transversally and rotate by 360 degrees, according to claim 1, wherein the rotation mechanism includes an L-shaped piece, a U-shaped piece, two fixing pieces and a rotation element, with that the L-shaped piece is latched in the rabbet of the connecting rod, the two fixing pieces and the rotation element are put in the U-shaped piece, a fixing piece is connected with the U-shaped piece and the U-shaped piece is combined with the rotation element.

5. The table lamp having a lamp shade that can displace transversally and rotate by 360 degrees, according to claim 1, wherein an interior of the lamp shade is provided with a slide rail, a bottom end of which is installed with a light emitting element, with that the slide rail allows the slide base to be put in, an interior of the slide base is installed with an aluminum element, and a side is connected with another fixing piece of the rotation mechanism; the lamp shade displacing transversally on the slide rail by the slide base and also rotating by 360 degrees on the connecting rod by the rotation mechanism.
